(19) United States
(12) Patent Application Publication
(10) Pub. No.: US 2022/0225701 A1
(43) Pub. Date: Jul. 21, 2022

(54) NON-MEDICAL FACE MASK

(71) Applicant: Karen Ann Rebecca Ritchie, Barrie (CA)

(72) Inventor: Karen Ann Rebecca Ritchie, Barrie (CA)

(21) Appl. No.: 17/150,747

(22) Filed: Jan. 15, 2021

(51) Int. Cl. A41D 13/11

(52) U.S. Cl. CPC A41D 13/1115; A41D 13/1161

(57) ABSTRACT

A face mask includes a body, two cords, and a retaining bead having a cord constraining passage. The body has upper and lower body edges spaced apart from one another by opposed left and right body edges. The body has left and right cord channels along the left and right body edges, respectively. Each cord extends from a first end, through a corresponding one of the left and right cord channels, to a second end. Each cord has first and second segments proximate the first and second ends, respectively. The first and second segments of each cord pass through the cord constraining passage. The cord constraining passage is sized to frictionally engage the first and second segments of each cord such that the retaining bead holds its position. The retaining bead is slidable along the first and second segments of each cord to advance the retaining bead toward the body.

### FIELD

This application relates to the field of personal protective equipment, and more particularly to a non-medical face mask that can be worn to mitigate transmission of contagions.

### INTRODUCTION

Non-medical face masks are well known. Such face masks are typically worn so that they cover the user's nose and mouth to inhibit passage of virus-carrying droplets. In this way, face masks can be worn to mitigate the spread of contagions, such as coronavirus, influenza, and other respiratory viruses. Known face masks are held against the user's face by elastic straps that wrap around the user's ear. Elastic straps cause stress and discomfort on the user's ears and can even cause sores after prolonged use.

Users have heads and ears in a variety of shapes and sizes. Furthermore, everyone has their own preferences when it comes to how to wear their face mask. For example, some users may prefer to wear their face mask as tight to their face as possible, while others may prefer a looser fit if they are required to wear their face mask for extended periods of time. Known face masks do not account for such variance, offering little in the way of adjustability and/or customization.

### DRAWINGS

FIGS. 1A-1D are perspective, front, side, and rear views, respectively, of a user wearing an exemplary non-medical face mask;

FIG. 2 is a perspective view of a unitary retaining bead of the face mask of FIG. 1A;

FIGS. 3A-3B are perspective views of the face mask of FIG. 1A, with the retaining bead in different positions;

FIG. 4 is a detailed view of region A in FIG. 3A;

FIG. 5 is a cross-sectional view taken along line B-B in FIG. 4;

FIG. 6 is a side view of the face mask of FIG. 1A shown hanging from a user's neck while not in use;

FIGS. 7A-7C are side views of a user wearing the face mask of FIG. 1A, with the retaining bead in a raised position, an intermediate position, and a lowered position, respectively;

FIG. 8 is a top perspective view of a bendable nose bar that may be used with the face mask of FIG. 1A;

FIG. 9 is a side view of the face mask of FIG. 1A; and

FIGS. 10A-10B are perspective and front views, respectively, of another exemplary non-medical face mask.

### SUMMARY

In one aspect, a non-medical face mask is disclosed. The face mask may include a mask body, a left cord, a right cord, and a unitary retaining bead having a cord constraining passage. The mask body may have upper and lower body edges spaced apart from one another by laterally opposed left and right body edges. The mask body may have a left cord channel along the left body edge and a right cord channel along the right body edge. The left cord may extend from a left cord first end through the left cord channel to a left cord second end. The left cord may be slidable within the left cord channel. The left cord may have a left cord first segment proximate the left cord first end and a left cord second segment proximate the left cord second end. The right cord may extend from a right cord first end through the right cord channel to a right cord second end. The right cord may be slidable within the right cord channel. The right cord may have a right cord first segment proximate the right cord first end and a right cord second segment proximate the right cord second end. Each of the left cord first segment, the left cord second segment, the right cord first segment and the right cord second segment may pass through the cord constraining passage. The cord constraining passage may be sized to frictionally engage the left cord first segment, the left cord second segment, the right cord first segment and the right cord second segment such that the unitary retaining bead is held in place along each of the left cord first segment, the left cord second segment, the right cord first segment and the right cord second segment. The unitary retaining bead may be slidable along each of the left cord first segment, the left cord second segment, the right cord first segment and the right cord second segment to advance the unitary retaining bead toward the mask body.

In another aspect, a non-medical face mask is disclosed. The face mask may include a mask body, a left cord, a right cord, and a unitary retaining bead having a cord constraining passage. The mask body may have upper and lower body edges spaced apart from one another by laterally opposed left and right body edges. The mask body may have a left cord channel along the left body edge and a right cord channel along the right body edge. The left cord may extend from a left cord first end through the left cord channel to a left cord second end. The left cord may have a left cord first segment proximate the left cord first end and a left cord second segment proximate the left cord second end. The right cord may extend from a right cord first end through the right cord channel to a right cord second end. The right cord may have a right cord first segment proximate the right cord first end and a right cord second segment proximate the right cord second end. Each of the left cord first segment, the left cord second segment, the right cord first segment and the right cord second segment may pass through the cord constraining passage. The cord constraining passage may be sized to frictionally engage the left cord first segment, the left cord second segment, the right cord first segment and the right cord second segment such that the unitary retaining bead is held in place along each of the left cord first segment, the left cord second segment, the right cord first segment and the right cord second segment. The unitary retaining bead may be slidable along each of the left cord first segment, the left cord second segment, the right cord first segment and the right cord second segment to advance the unitary retaining bead toward the mask body. The left cord first and second ends may be tied through a left cord knot. The right cord first and second ends may be tied through a right cord knot. The left cord knot may obstruct removal of the unitary retaining bead from the left cord first and second ends. The right cord knot may obstruct removal of the unitary retaining bead from the right cord first and second ends.

In another aspect, a non-medical face mask is disclosed. The face mask may include a mask body, a left cord, a right cord, and a unitary retaining bead having a cord constraining passage. The mask body may have upper and lower body edges spaced apart from one another by laterally opposed left and right body edges. The left cord may extend from a left cord first end to a left cord second end. The left cord may have a connection to the left body edge between the left cord first and second ends The left cord may have a left cord first segment proximate the left cord first end and a left cord second segment proximate the left cord second end. The right cord may extend from a right cord first end to a right cord second end. The right cord may have a connection to the right body edge between the right cord first and second ends. The right cord may have a right cord first segment proximate the right cord first end and a right cord second segment proximate the right cord second end. Each of the left cord first segment, the left cord second segment, the right cord first segment and the right cord second segment may pass through the cord constraining passage. The cord constraining passage may be sized to frictionally engage the left cord first segment, the left cord second segment, the right cord first segment and the right cord second segment such that the unitary retaining bead is held in place along each of the left cord first segment, the left cord second segment, the right cord first segment and the right cord second segment. The unitary retaining bead may be slidable along each of the left cord first segment, the left cord second segment, the right cord first segment and the right cord second segment to advance the unitary retaining bead toward the mask body. The left cord first and second ends may be tied through a left cord knot. The right cord first and second ends may be tied through a right cord knot. The left cord knot may obstruct removal of the unitary retaining bead from the left cord first and second ends. The right cord knot may obstruct removal of the unitary retaining bead from the right cord first and second ends.

### DESCRIPTION OF VARIOUS EMBODIMENTS

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)”, unless expressly specified otherwise.

The terms “including”, “comprising” and variations thereof mean “including but not limited to”, unless expressly specified otherwise. A listing of items does not imply that any or all of the items are mutually exclusive, unless expressly specified otherwise. The terms “a”, “an” and “the” mean “one or more”, unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

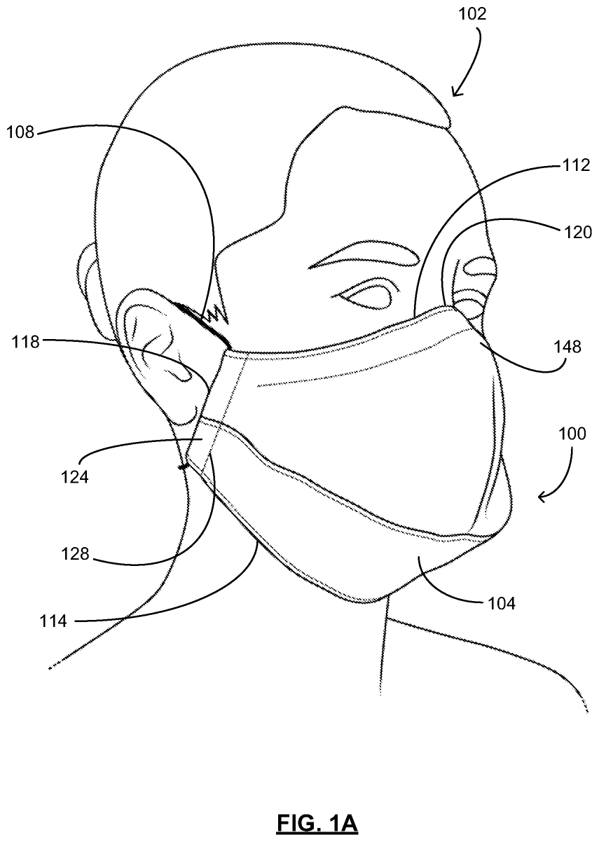

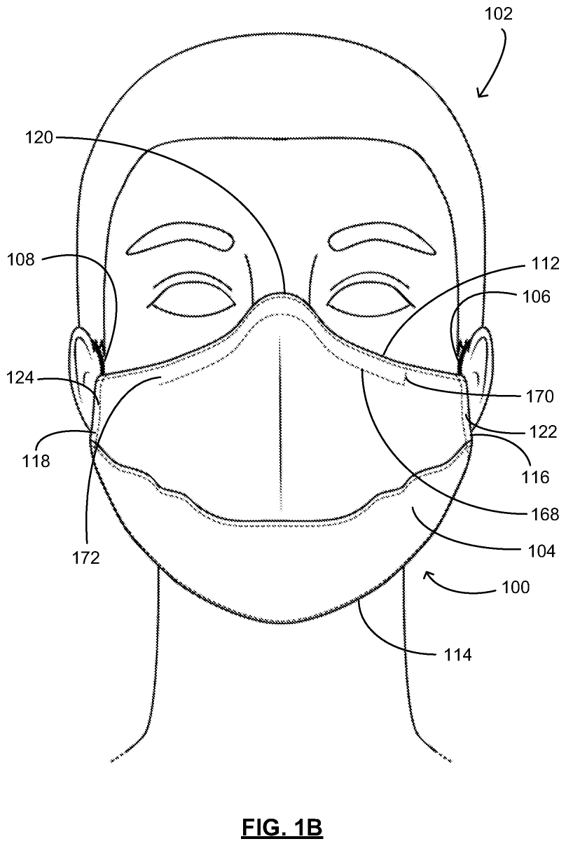

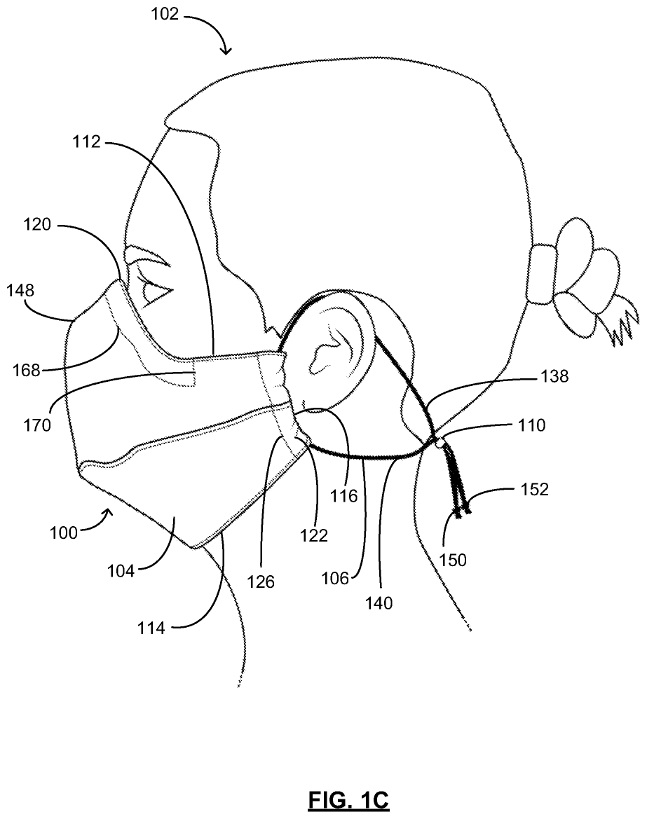

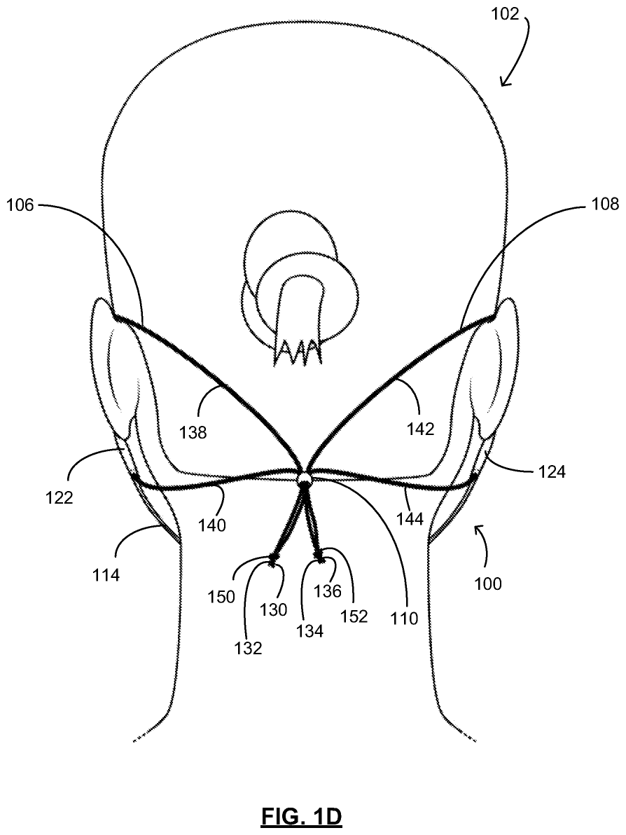

FIGS. 1A-1D show a non-medical face mask 100 worn by a user 102. Face mask 100 includes a mask body 104, a left cord 106, a right cord 108 and a unitary retaining bead 110. As shown in FIGS. 1C and 1D, unitary retaining bead 110 cooperates with left cord and right cords 106, 108 to hold mask body 104 against the user's face.

Referring to FIG. 1B, mask body 104 has upper and lower body edges 112, 114 spaced apart from one another by laterally opposed left and right body edges 116, 118. As shown, mask body 104 is sized to cover the user's nostrils and mouth. By covering the user's nostrils and mouth, mask body 104 can impede user-expelled droplets from entering the surrounding environment. Mask body 104 can also impede entry of droplets from the surrounding environment into the user's nostrils and mouth. These droplets may be carriers of contagions, such as COVID-19 or influenza, for example. As a result, users can help limit peer-to-peer transmission of such contagions by wearing face mask 100 over their mouth and nostrils.

In the example shown, mask body 104 is worn so that upper body edge 112 spans laterally across the user's face, i.e. below the eyes. Upper body edge 112 has a central nose-engaging region 120 that sits on the bridge of the user's nose. Accordingly, the user's nose may act as a support for mask body 104. As best shown in FIG. 1C, lower body edge 114 wraps underneath the user's chin, i.e. from ear-to-ear. Positioning mask body 104 in such a way allows the lower part of mask body 104 to effectively “cup” the user's chin, providing an enclosed fit that can limit the passage of contagion-carrying droplets.

Mask body 104 can be made from various types of material. Pliant fabrics can readily conform to the unique shape of each user's face, thereby promoting user comfort. In addition, pliant fabrics permit mask body 104 to be folded for convenient storage while not in use. For example, the pliant fabric may comprise cotton, flannel, chiffon, silk, or a combination thereof. Mask body 104 may include one or more layers of pliant fabric. In some embodiments, mask body 104 may include multiple layers of pliant fabric. Compared to a mask body 104 with a single layer of pliant fabric, a mask body 104 with multiple layers of pliant fabric may make it more difficult for droplets to pass through. For example, mask body 104 may include three layers of tightly woven cotton to effectively prevent against the passage of droplets. In some embodiments, the outer layers of pliant fabric may be selected for softness (e.g. cotton or silk), and the inner layer(s) of pliant fabric may be selected for their efficiency at filtering contagion. For example, an inner layer may include a filter material, such as a non-woven filter material (e.g. non-woven polypropylene). In alternative embodiments, mask body 104 may comprise a rigid or semi-rigid material, such as a hard or soft plastic.

With reference to FIGS. 1A and 1C, left and right cords 106, 108 may be connected to mask body 104 in any manner that allows cords 106, 108 to cooperate with unitary retaining bead 110 to securely hold mask body 104 to a user's head. In the illustrated example, mask body 104 has a left cord channel 122 along the left body edge 116 and a right cord channel 124 along the right body edge 118. Left and right cord channels 122, 124 are sized so that corresponding left and right cords 106, 108 can pass therethrough. Left and right cord channels 122, 124 can be formed in any suitable manner. In some embodiments, left and right cord channels 122, 124 can be formed by the pliant fabric of mask body 104 itself. For example, as shown in FIGS. 1A and 1C, left and right cord channels 122, 124 are bounded by corresponding first and second hems 126, 128 of the pliant fabric at laterally opposed fabric ends. In alternative embodiments, left and right cord channels 122, 124 can be provided by hollow tubes attached along left and right body edges 116, 118 of mask body 104.

Referring to FIG. 1D, left cord 106 extends from a left cord first end 130, through left cord channel 122, to a left cord second end 132. Similarly, right cord 108 extends from a right cord first end 134, through right cord channel 124, to a right cord second end 136. In the example shown, left and right cords 106, 108 are slidable within corresponding left and right cord channels 122, 124. Alternatively, left and right cords 106, 108 may not be slidable within corresponding left and right cord channels 122, 124. For example, left and right cords 106, 108 may be sewn to mask body 104 along corresponding left and right channels 122, 124. Being able to slide the left and right cords 106, 108 within corresponding cord channels 122, 124 can provide users of these face masks 100 with greater adjustability compared to those where left and right cords 106, 108 cannot slide within corresponding left and right cord channels 122, 124. Conversely, face masks 100 in which left and right cords 106, 108 cannot slide within corresponding left and right cord channels may simplify operation and/or improve durability compared to those where left and right cords 106, 108 can slide within corresponding left and right cord channels 122, 124.

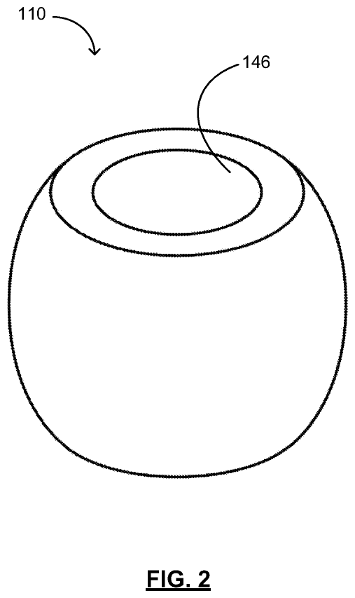

Referring to FIG. 2, unitary retaining bead 110 has a cord constraining passage 146. Cord constraining passage 146 extends completely through unitary retaining bead 110 (i.e. from one end to the other). Cord constraining passage 146 may have any physical configuration (e.g. shape) suitable to make frictional engagement with cords 106, 108 passing therethrough. In the example shown, cord constraining passage 146 is cylindrical. In alternative embodiments, the cross-section of cord constraining passage 146 may have another regular shape (e.g. rectangular, triangular, ovular, etc.) or irregular shape (e.g. cardiod shape, or clover shape). As used herein, the term “unitary” as it pertains to unitary retaining bead 110 means that unitary retaining bead 110 is free of moving parts, such as push buttons or springs. Unitary retaining bead 110 may be made of various types of materials, such as metal, glass, wood, ceramic, or plastic. Plastic beads may be advantageous due to their relatively low cost and weight. However, ceramic and metal beads may be more durable than plastic beads.

Referring again to FIG. 1D, left cord 106 has a left cord first segment 138 proximate the left cord first end 130 and a left cord second segment 140 proximate the left cord second end 132. Similarly, right cord 108 has a right cord first segment 142 proximate the right cord first end 134 and a right cord second segment 144 proximate the right cord second end 136. As shown, each of left cord first segment 138, left cord second segment 140, right cord first segment 142 and the right cord second segment 144 are fed through cord constraining passage 146 (FIG. 2).

Cord constraining passage 146 (FIG. 2) is sized to frictionally engage left cord first segment 138, left cord second segment 140, right cord first segment 142 and right cord second segment 144 such that retaining bead 110 is held in place along each of cord segments 138, 140, 142, and 144. That is, unitary retaining bead 110 can maintain its position by virtue of the friction generated between cord constraining passage 146 and each of cord segments 138, 140, 142, and 144. A user is able to slide retaining bead 110 (e.g. with their fingers) in either direction along cord segments 138, 140, 142, and 144 when that user applies a force sufficient to overcome the friction generated along cord constraining passage 146.

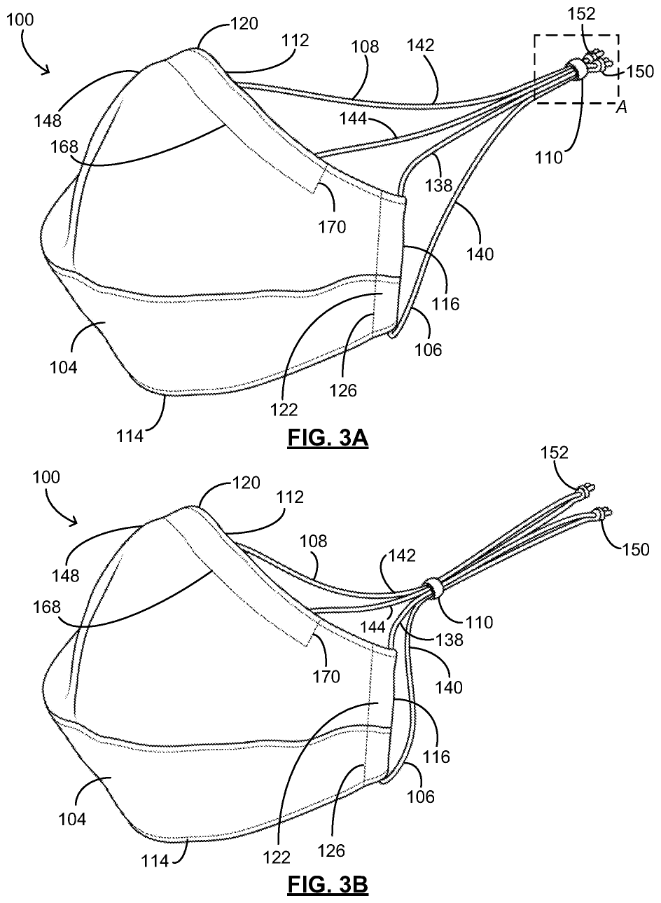

A comparison of FIGS. 3A and 3B illustrates an example advancement of unitary retaining bead 110 along each of cord segments 138, 140, 142, and 144 toward mask body 104. Such advancement may be performed by a user in order to secure (i.e. tighten) mask body 104 against their face. For example, FIGS. 1C and 1D show unitary retaining bead 110 advanced until reaching the nape of the user's neck. In this position, unitary retaining bead 110 and left and right cords 106, 108 cooperate to hold mask body 104 firmly against the user's face. To loosen or remove mask body 104, the user can slide unitary retaining bead 110 in the opposite direction (i.e. away from mask body 104 along cord segments 138, 140, 142, and 144).

Face mask 100 offers a reduction in pressure and stress applied to the user by not requiring straps to be wrapped around the ears to support mask body 104 on the user's face. Using face mask 100 may reduce or eliminate the pressure, stress and/or sores commonly caused by face masks with elastic ear straps.

Various shapes of mask body 104 are possible. Referring to FIGS. 3A and 3B, the illustrated mask body 104 is concave so that additional room is provided around the user's nose and mouth. Mask body 104 has an enlarged nose region 148, which contributes to this additional room around the user's nose. This room around the nose and mouth may make it easier for the user to breathe while wearing face mask 100. The room around the nose and mouth afforded by the concave shape of mask body 104 may also increase user comfort by applying less stress on the user's face and, more specifically, the user's nose.

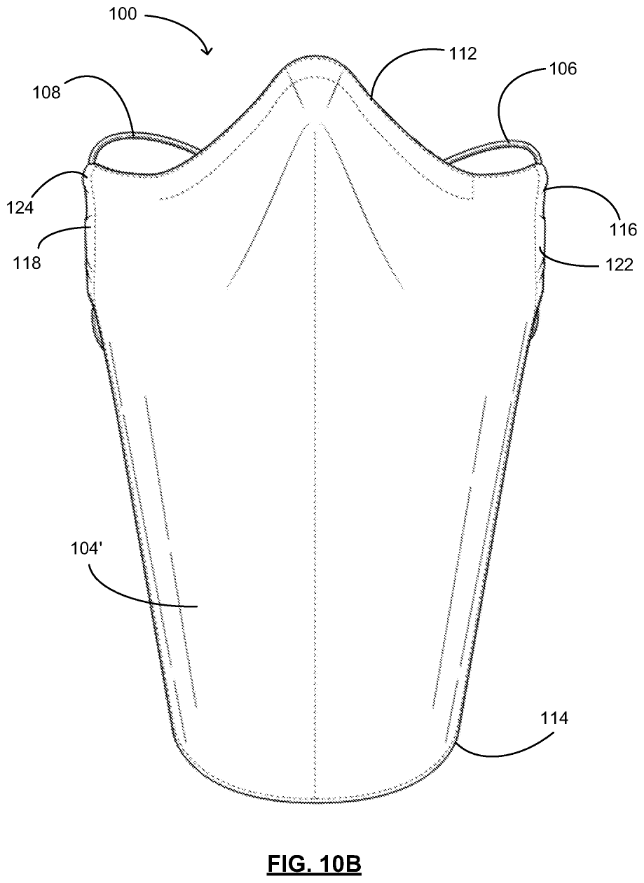

FIGS. 10A-10B show a face mask 100 having a mask body 104′ with a different shape than mask body 104 of FIGS. 3A-3B. Similar to mask body 104, mask body 104′ has upper and lower body edges 112, 114 spaced apart from one another by laterally opposed left and right body edges 116, 118. As shown, mask body 104′ has an extended lower body edge 114 to give mask body 104′ an elongated shape that covers the user's mouth and chin. By not wrapping around the user's chin, mask body 104′ may simplify breathing as expelled air from the user's mouth and nose can more readily pass around mask body 104′. Furthermore, the elongated shape of mask body 104′ may be well suited for user's with beards. Instead of pinching the user's bead along lower body edge 114, the shape of mask body 104′ allows it to cover (i.e. drape) a portion or all of the user's beard. This may improve user comfort and/or aesthetic appeal while wearing face mask 100.

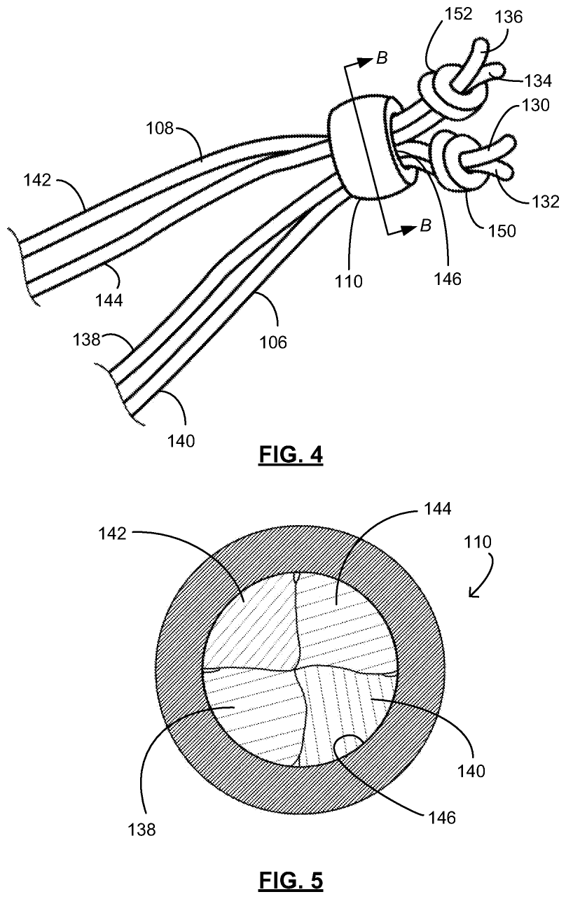

Referring to FIG. 4, unitary retaining bead 110 is shown trapped on cord segments 138, 140, 142, and 144 inboard of cord ends 130, 132, 134, 136. This can prevent unitary retaining bead 110 from disengaging with any of cord segments 138, 140, 142 and 144 (e.g. due to over sliding retaining bead 110 in the direction away from mask body 104). There are a variety of suitable ways to trap retaining bead 110 on cord segments 138, 140, 142, and 144. For example, left cord first end 130, left cord second end 132, right cord first end 134 and right cord second end 136 can be tied into a single knot after being passed through cord constraining passage 146 (FIG. 2). Being larger than cord constraining passage 146, this knot can prevent left cord first end 130, left cord second end 132, right cord first end 134 and right cord second end 136 from being pulled back through cord constraining passage 146. In other embodiments, mechanical fasteners (e.g. clamps, clips, etc.) may be used to tie left cord first end 130, left cord second end 132, right cord first end 134 and right cord second end 136 after they are passed through cord constraining passage 146. Like the knot, the size of the mechanical fastener may prevent left cord first end 130, left cord second end 132, right cord first end 134 and right cord second end 136 from being pulled back through cord constraining passage 146.

In at least one embodiment (not shown), left cord first end 130 and right cord first end 134 are fed through cord constraining passage 146 and tied into a first cord knot. Similarly, left cord second end 132 and right cord second end 136 are fed through cord constraining passage 146 and tied into a second cord knot. Tying left cord first end 130 and right cord first end 134 separately from left cord second end 132 and right cord second end 136 may enhance mask adjustability. In such a configuration, left cord first segment 138 and right cord first segment 142 can be slid together through cord constraining passage 146 independently of left cord second segment 140 and right cord second segment 144. This can allow the user to better customize the upper and lower fit of mask body 104 over their face. For example, the user may prefer mask body 104 held tighter against their face along upper body edge 112 than lower body edge 114.

In the example shown, after being fed through cord constraining passage 146, left cord first and second ends 130, 132 are tied through a left cord knot 150, and right cord first and second ends 134, 136 are tied through a right cord knot 152. As shown in FIG. 4, cord knots 150, 152 are preferably tied so that only a short tail is left. By virtue of its size relative to cord constraining passage 146, left cord knot 150 obstructs removal of retaining bead 110 from left cord first and second ends 130, 132. Similarly, the size of right cord knot 152 obstructs removal of retaining bead 110 from right cord first and second ends 134, 136. In some embodiments, left and right cord knots 150 and 152 are fused to make the knots 150, 152 permanent and thereby impede unknotting and/or fraying. This may increase the lifespan of face mask 100. For example, where polyester cords are used, each cord knot 150, 152 may be fused by holding it over a heat source, such as a flame or resistive heating element. The polyester melts and resolidifies as it cools, fusing the knots.

Tying left cord first and second ends 130, 132 separately from right cord first and second ends 134, 136 as shown may provide benefits from a mask adjustability standpoint. In this configuration, left cord first and second segments 138, 140 can be slid together through cord constraining passage 146 independently of right cord first and second segments 142, 144. This can allow the user to independently adjust the fit of mask body 104 on opposite sides of their face. For example, a user with a hearing aid on their left ear may require a looser mask fit on that side of their face.

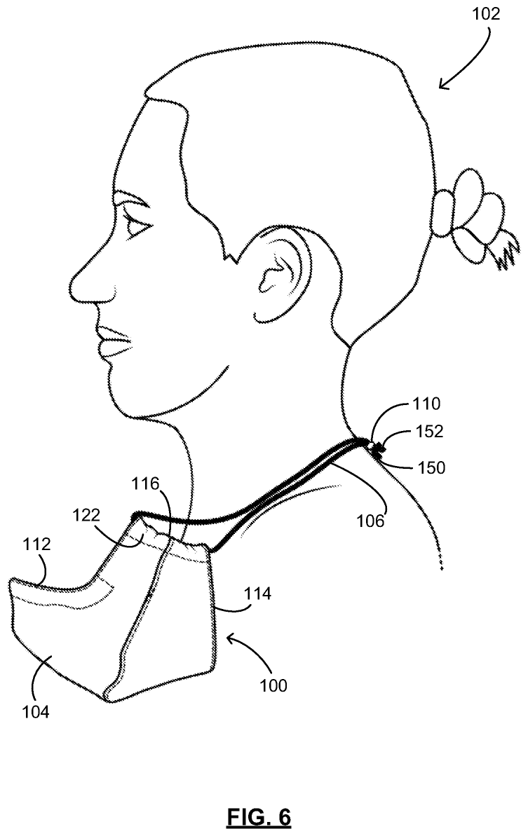

As described above, cord constraining passage 146 (FIG. 2) is sized to frictionally engage left cord first segment 138, left cord second segment 140, right cord first segment 142 and right cord second segment 144. As shown in FIG. 5, a portion of each cord segment 138, 140, 142 and 144 that is within the cord constraining passage 146 is compressed by unitary retaining bead 110.

Each of left cord first segment 138, left cord second segment 140, right cord first segment 142 and right cord second segment 144 have an “uncompressed” cord cross-sectional area (i.e. a cross-sectional area when not compressed by unitary retaining bead 110). Retaining bead 110 compresses cord segments 138, 140, 142 and 144 such that the sum of the cross-sectional areas of cord segments 138, 140, 142, and 144 within the cord constraining passage 146 is reduced by at least 25% (e.g. reduced by 25% to 75%). This degree of compression of cord segments 138, 140, 142, 144 within cord constraining passage 146 can generate the friction necessary to maintain the position of retaining bead 110 along cord segments 138, 140, 142, 144. At the same time, this degree of compression of cord segments 138, 140, 142, 144 within cord constraining passage 146 still allows a user to slide retaining bead 110 along cord segments 138, 140, 142, 144 through the application of a reasonable amount of force.

In some embodiments, the sum of the cord cross-sectional areas of cord segments 138, 140, 142, and 144 may be about 1.8 to 2.8 times greater than a cross-sectional area of cord constraining passage 146. More preferably, the sum of the cord cross-sectional areas of cord segments 138, 140, 142, and 144 may be about 2.0 to 2.5 times greater than a cross-sectional area of cord constraining passage 146. As an example, each cord segment 138, 140, 142, and 144 may have a cord cross-sectional area of about 7 mm². Accordingly, the sum of the cross-sectional areas is about 28 mm² (7 mm²+7 mm²+7 mm²+7 mm²). Cord constraining passage 146 may have a cross-sectional area of about 12.5 mm². In this example, the sum of the cord cross-sectional areas of cord segments 138, 140, 142, and 144 is about 2.2 times greater than a cross-sectional area of cord constraining passage 146 (28 mm²÷12.5 mm²).

Left and right cords 106, 108 may be made of various types of materials. For example, left and right cords 106, 108 may comprise polyester, nylon, polypropylene, aramid, or a combination thereof. In some embodiments, left and right cords 106, 108 may be one of a braided polyester cord, a braided nylon cord, a braided polypropylene cord, and a braded aramid cord. In other embodiments, left and right cords 106, 108 may be one of a twisted polyester cord, a twisted nylon cord, a twisted polypropylene cord, and a twisted aramid cord. Braided cord may provide one or more advantages over twisted cord. For example, braided cord is generally stronger, smoother to the touch, more durable, less stretchable than twisted cord. However, twisted cord is typically less expensive than braided cord. Lower costs may be an important consideration for establishments (e.g. retail, dining, medical, or government service) who may purchase hundreds or thousands of non-medical face mask 100 for use by their patrons.

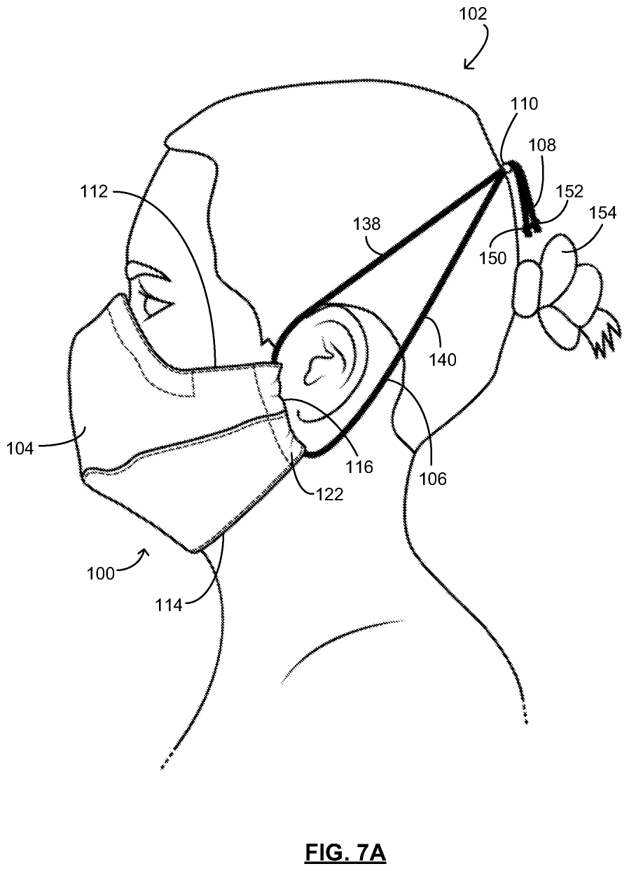

Left and right cords 106, 108 may have a length that allows face mask 100 to be loosened and worn around the neck (FIG. 6). For example, left and right cords 106, 108 may be between 70 and 100 cm in length. More preferably, left and right cords 106, 108 are between 80 and 90 cm in length. In the example shown, left and right cords 106, 108 have the same cord length. Left and right cords 106, 108 of similar length may simplify use and/or manufacturing of face mask 100. Alternatively, left and right cords 106, 108 may have different cord lengths. For example, left cord 106 may have a cord length of 85 cm and right cord 108 may have a cord length of 90 cm.

Left and right cords 106, 108 may have an elasticity of less than 20%. More preferably, left and right cords 106, 108 have an elasticity less than 10%. In this context, elasticity is defined as:

$$\frac{( final cord length under a tension of 5 N ) - ( relaxed cord length )}{relaxed cord length} \times 100 \% .$$

Operation of face mask 100 can be simplified through the use of left and rights cords 106, 108 that are relatively inelastic (i.e. have an elasticity below 20%). If left and right cords 106, 108 were easily stretched, sliding retaining bead 110 along cord segments 138, 140, 142, and 144 would be cumbersome (i.e. cord segments 138, 140, 142, 144 would bunch up adjacent retaining bead 110). Further, cord durability is generally inversely correlated with increasing cord elasticity. That is, cords with a lower elasticity tend to last longer than cord with a higher elasticity. Accordingly, using left and right cords 106, 108 that are relatively inelastic can increase the lifespan of face mask 100. Still, in alternative embodiments, cords 106, 108 may have an elasticity greater than 20%.

Referring to FIG. 6, face mask 100 can be conveniently worn around the neck of user 102 at times when contagion protection is not needed (e.g. when alone outdoors in open air). In these cases, the user 102 can loosen mask body 104 from their face by sliding retaining bead 110 away from their head and then lower or drop mask body 104 to their chest. When protection is again needed, the user 102 can raise mask body 104 up to their face and advance retaining bead 110 toward their head until mask body 104 is sufficiently secure. Being able to let mask body 104 hang from the neck can be particularly advantageous for users who frequently transition between situations where contagion protection is needed and not needed. It may also act to reduce the frequency with which face mask 100 is misplaced or lost since it can be easily kept around the user's neck when not in use (i.e. instead of being unintentionally forgotten somewhere).

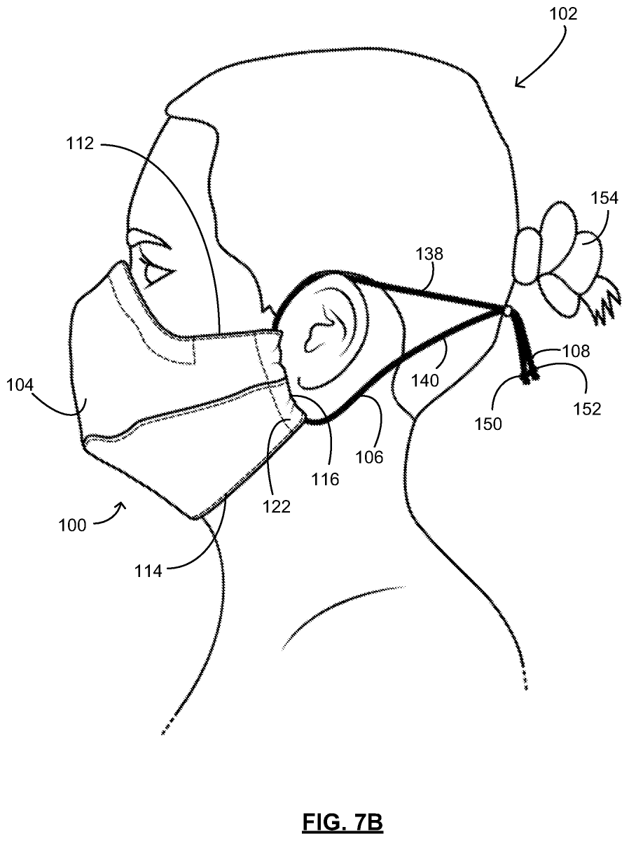

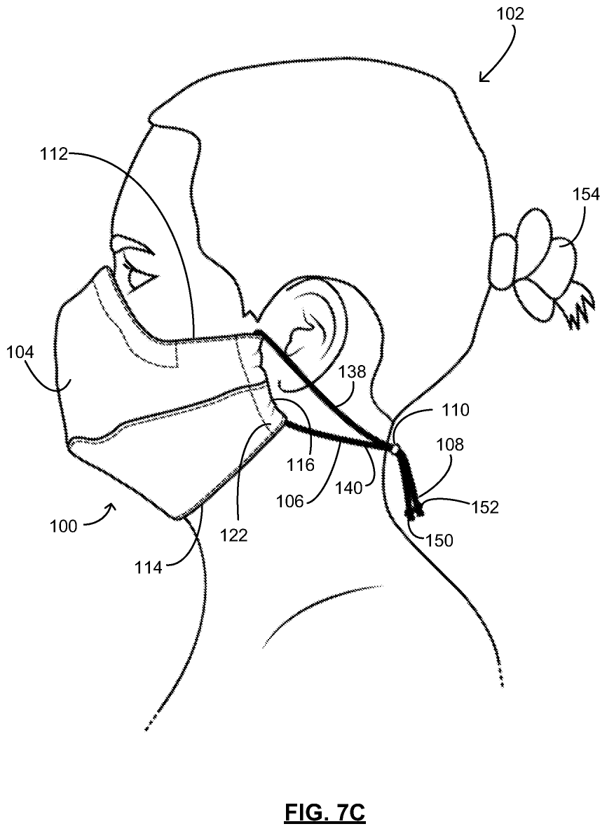

FIGS. 7A-7C illustrate different exemplary ways in which face mask 100 can be worn. FIG. 7A shows user 102 with retaining bead 110 in a raised position against the back of her head (e.g. above hair bun 154). FIG. 7B shows user 102 with retaining bead 110 positioned in an intermediate position against the back of her head (e.g. just below hair bun 154). FIG. 7C shows user 102 with retaining bead 110 in a lowered position against the back of her head. In each of these positions, left and right cords 106, 108 do not wrap around the user's ears for support. As a result, face mask 100 does not apply any pressure to the back of the user's ears when it is worn.

As described above, the friction generated between cord constraining passage 146 and cord segments 138, 140, 142, and 144 acts to retain the position of retaining bead 110. It is the position of the retaining bead 110 along each of cord segments 138, 140, 142 and 144 that dictates the tightness/looseness of the face mask 100. With the generated friction holding the retaining bead 110 in a static position, little additional support is needed from the user's head to keep mask body 104 held firmly against the user's face. As a result, face mask 100 can provide the user with a comfortable mask wearing experience.

Referring again to FIG. 1B, mask body 104 includes a laterally extending nose bar channel 168 located along upper mask body edge 112. It may be convenient to centrally locate nose bar channel 168 along upper mask body edge 112 (e.g. as shown); however, this does not need to be the case. For example, nose bar channel 168 can be offset toward either one of left or right body edges 116, 118. Nose bar channel 168 is sized so that a bendable nose bar is insertable therein. Bendable nose bars allow the user to adjust the fit of upper body edge 112 over their nose according to their own preferences. For example, a user may bend nose bar 174 to conform to the shape of their nose to close gaps between the body upper edge 112 and the user's face. In turn, this may mitigate the escape of exhaled air through such gaps, reduce the spread of contagions in such exhaled air, and prevent users' glasses from fogging due to contact with the exhaled air.

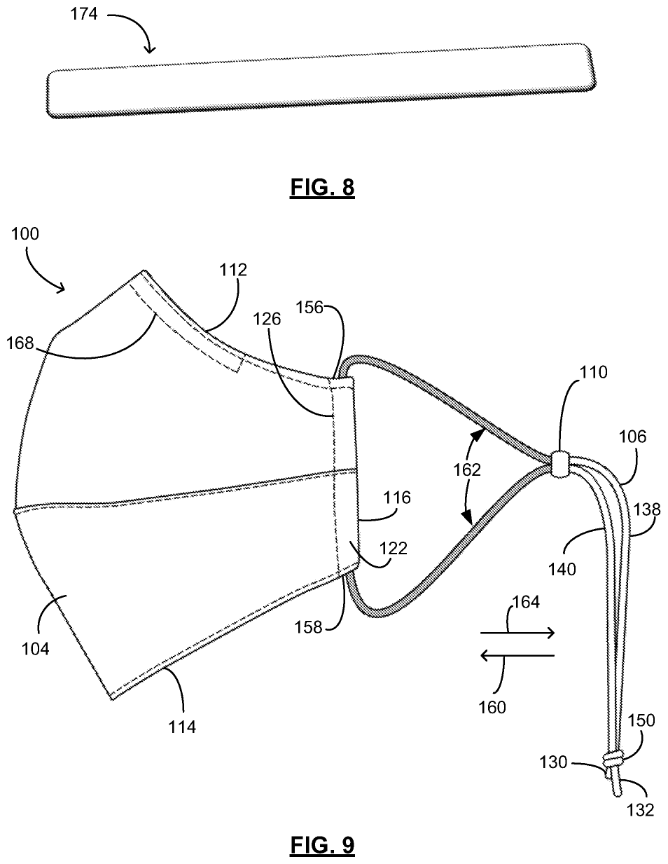

Nose bar channel 168 may be formed in any manner that allows channel 168 to retain a nose bar 174 (FIG. 8). For example, nose bar channel 168 may be formed by the pliant fabric of mask body 104. In the example shown, adjacent layers of pliant fabric are sewn together to create nose bar channel 168. Alternatively, nose bar channel 168 may be formed by joining (e.g. sewing) an additional piece of fabric to the inner surface of mask body 104 adjacent body upper edge 112 with one or more edges of the appended piece of fabric left detached to form a bar insertion opening.

In the example shown, nose bar channel 168 has a closed end 170 and an opposed open end 172 (also referred to as nose bar insertion opening 172). A bendable nose bar, such as bendable and resilient nose bar 174 shown in FIG. 8, can be inserted into nose bar channel 168 through open end 172. The nose bar can also be removed from open end 172, e.g. to substitute in a new nose bar or to remove the nose bar all together. In one embodiment, a kit is provided that includes face mask 100 and at least two nose bars 174 (FIG. 8). For example, 2 to 10 nose bars 174 may be included in the kit. Accordingly, the kit provides the user with at least one replacement nose bar 174. This could be particularly beneficial in situations where the primary nose bar 174 is misplaced, damaged and/or looses its resiliency through repeated use.

Closed end 170 of nose bar channel 168 can be sealed in any suitable manner. In the example shown, closed end 170 of nose bar channel 168 is stitched closed. In some embodiments, the position of closed end 170 is associated with the length of the nose bar so that when the nose bar is fully inserted into the nose bar channel 168, the nose bar is centrally aligned with upper body edge 112. In alternative embodiments, end 170 of nose bar channel 168 is also open so that nose bar 174 may be inserted through either end 170, 172.

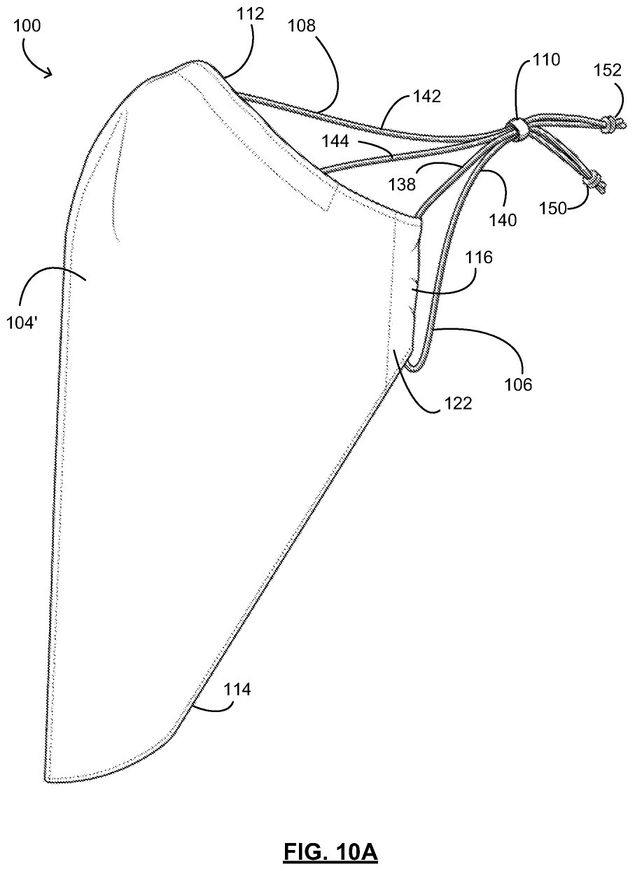

Referring to FIG. 9, left cord channel 122 extends from a left channel upper exit 156 to a left channel lower exit 158. Advancing retaining bead 110 toward mask body 104 (in direction 160) reduces a portion 162 of left cord 106 that extends from retaining bead 110 to each of left channel upper and lower exits 156, 158 (i.e. total length of portion 162 is reduced).

For greater clarity, portion 162 of left cord 106 is shaded in FIG. 9 to distinguish it from the rest of left cord 106. Making portion 162 of left cord 106 smaller has a mask tightening effect. On the other hand, making portion 162 of left cord 106 larger (i.e. by sliding retaining bead 110 in direction 164) has a mask loosening effect. This applies mutatis mutandis to right cord 108, right cord channel 124 and retaining bead 110.

Referring still to FIG. 9, left cord channel 122 has a left cord channel length 166 (i.e. from left channel upper exit 156 to left channel lower exit 158). Left cord 106 has a left cord length (i.e. from left cord first end 130 to left cord second end 132). In some embodiments, a ratio of the left cord length to the left cord channel length is between 18 to 1 and 8 to 1. More preferably, the ratio of the left cord length to the left cord channel length is between 15 to 1 and 10 to 1. As an example, the left cord length may be 86 cm and the left cord channel length may be 6 cm, making the ratio about 14.3 to 1. Having a ratio of the left cord length to the left cord channel length within the ranges above can ensure face mask 100 fits comfortably over the user's head while being put on. Alternatively, or in addition, a ratio within these ranges can also provide face mask 100 with sufficient slack to be worn around the user's neck as shown in FIG. 6. The above description applies mutatis mutandis to right cord 108 and right cord channel 124.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples but should be given the broadest interpretation consistent with the description as a whole.

### Items

Item 1: A non-medical face mask comprising:

a mask body having upper and lower body edges spaced apart from one another by laterally opposed left and right body edges, the mask body having a left cord channel along the left body edge and a right cord channel along the right body edge;

a left cord extending from a left cord first end through the left cord channel to a left cord second end, the left cord being slidable within the left cord channel, the left cord having a left cord first segment proximate the left cord first end and a left cord second segment proximate the left cord second end;

a right cord extending from a right cord first end through the right cord channel to a right cord second end, the right cord being slidable within the right cord channel, the right cord having a right cord first segment proximate the right cord first end and a left cord second segment proximate the right cord second end; and

a unitary retaining bead having a cord constraining passage, each of the left cord first segment, the left cord second segment, the right cord first segment and the right cord second segment passing through the cord constraining passage, the cord constraining passage being sized to frictionally engage the left cord first segment, the left cord second segment, the right cord first segment and the right cord second segment such that the unitary retaining bead is held in place along each of the left cord first segment, the left cord second segment, the right cord first segment and the right cord second segment, the unitary retaining bead being slidable along each of the left cord first segment, the left cord second segment, the right cord first segment and the right cord second segment to advance the unitary retaining bead toward the mask body.

Item 2: The non-medical face mask of any preceding item, wherein:

a portion of each of the left cord first segment, the left cord second segment, the right cord first segment and the right cord second segment that is within the cord constraining passage is compressed by the unitary retaining bead.

Item 3: The non-medical face mask of any preceding item, wherein:

each of the left cord first segment, the left cord second segment, the right cord first segment and the right cord second segment have a cord cross-sectional area, a sum of the cord cross-sectional areas of the left cord first segment, the left cord second segment, the right cord first segment and the right cord second segment being about 2 to 2.5 times greater than a cross-sectional area of the cord constraining passage.

Item 4: The non-medical face mask of any preceding item, wherein:

each of the left cord first segment, the left cord second segment, the right cord first segment and the right cord second segment have a cord cross-sectional area, and the unitary retaining bead reduces a sum of the cord cross-sectional areas of the left cord first segment, the left cord second segment, the right cord first segment and the right cord second segment within the cord constraining passage by at least 25%.

Item 5: The non-medical face mask of any preceding item, wherein:

the unitary retaining bead is trapped on each of the left cord first segment, the left cord second segment, the right cord first segment and the right cord second segment.

Item 6: The non-medical face mask of any preceding item, wherein:

the left cord first and second ends are tied, and the right cord first and second ends are tied.

Item 7: The non-medical face mask of any preceding item, wherein:

the left cord first end and the right cord first end are tied, and the left cord second end and the right cord second end are tied.

Item 8: The non-medical face mask of any preceding item, wherein:

the left cord first and second segments are together slidable through the cord constraining passage independently of the right cord first and second segments.

Item 9: The non-medical face mask of any preceding item, wherein:

the left cord first segment and the right cord first segment are together slidable through the cord constraining passage independently of the left cord second segment and the right cord second segment.

Item 10: The non-medical face mask of any preceding item, wherein:

the left cord first and second ends are tied through a left cord knot, and the right cord first and second ends are tied through a right cord knot, the left cord knot obstructing removal of the unitary retaining bead from the left cord first and second ends, and the right cord knot obstructing removal of the unitary retaining bead from the right cord first and second ends.

Item 11: The non-medical face mask of any preceding item, wherein:

the left cord first end and the right cord first end are tied through a first cord knot, and the left cord second end and the right cord second end are tied through a second cord knot, the first cord knot obstructing removal of the unitary retaining bead from the left cord first end and the right cord first end, and the second cord knot obstructing removal of the unitary retaining bead from the left cord second end and the right cord second end.

Item 12: The non-medical face mask of any preceding item, wherein:

each of the left and right cord knots are fused to impede unknotting.

Item 13: The non-medical face mask of any preceding item, wherein:

each of the first and second cord knots are fused to impede unknotting.

Item 14: The non-medical face mask of any preceding item, wherein:

each of the left and right cords have an elasticity of less than 10%.

Item 15: The non-medical face mask of any preceding item, wherein:

each of the left and right cords comprise one of braided polyester, braided nylon, braided polypropylene, and braided aramid.

Item 16: The non-medical face mask of any preceding item, wherein:

each of the left and right cords comprise one of polyester, nylon, polypropylene, and aramid.

Item 17: The non-medical face mask of any preceding item, wherein:

the left cord channel extends from a left channel upper exit to a left channel lower exit, the right cord channel extends from a right channel upper exit to a right channel lower exit, and advancing the unitary retaining bead toward the mask body reduces
i) a portion of the left cord that extends from the unitary retaining bead to each of the left channel upper and lower exits, and
ii) a portion of the right cord that extends from the unitary retaining bead to each of the right channel upper and lower exits.
   Item 18: The non-medical face mask of any preceding item, wherein:

the left cord has a left cord length, the right cord has a right cord length, the left cord channel has a left cord channel length, the right cord channel has a right cord channel length, a ratio of the left cord length to the left cord channel length is between 15 to 1 and 10 to 1, and a ratio of the right cord length to the right cord channel length is between 15 to 1 and 10 to 1.

Item 19: The non-medical face mask of any preceding item, wherein:

the mask body comprises at least one layer of pliant fabric having laterally opposed left and right fabric ends, and lengths of the left and right cord channels are bounded at least in part by respective hems of the left and right fabric ends.

Item 20: The non-medical face mask of any preceding item, wherein

the mask body comprises a laterally extending nose bar channel located along the upper mask body edge, the nose bar channel having a bendable nose bar insertion opening.

Item 21: A kit comprising:

the non-medical face mask of any preceding item; and

at least two bendable nose bars.

Item 22: A non-medical face mask comprising:

a mask body having upper and lower body edges spaced apart from one another by laterally opposed left and right body edges, the mask body having a left cord channel along the left body edge and a right cord channel along the right body edge;

a left cord extending from a left cord first end through the left cord channel to a left cord second end, the left cord having a left cord first segment proximate the left cord first end and a left cord second segment proximate the left cord second end;

a right cord extending from a right cord first end through the right cord channel to a right cord second end, the right cord having a right cord first segment proximate the right cord first end and a right cord second segment proximate the right cord second end; and

a unitary retaining bead having a cord constraining passage, each of the left cord first segment, the left cord second segment, the right cord first segment and the right cord second segment passing through the cord constraining passage, the cord constraining passage being sized to frictionally engage the left cord first segment, the left cord second segment, the right cord first segment and the right cord second segment such that the unitary retaining bead is held in place along each of the left cord first segment, the left cord second segment, the right cord first segment and the right cord second segment, the unitary retaining bead being slidable along each of the left cord first segment, the left cord second segment, the right cord first segment and the right cord second segment to advance the unitary retaining bead toward the mask body,

wherein the left cord first and second ends are tied through a left cord knot, and the right cord first and second ends are tied through a right cord knot, the left cord knot obstructing removal of the unitary retaining bead from the left cord first and second ends, and the right cord knot obstructing removal of the unitary retaining bead from the right cord first and second ends.

Item 23: The non-medical face mask of any preceding item, wherein:

the left cord is slidable within the left cord channel and the right cord is slidable within the right cord channel.

Item 24: The non-medical face mask of any preceding item, wherein:

a portion of each of the left cord first segment, the left cord second segment, the right cord first segment and the right cord second segment that is within the cord constraining passage is compressed by the unitary retaining bead.

Item 25: The non-medical face mask of any preceding item, wherein:

each of the left cord first segment, the left cord second segment, the right cord first segment and the right cord second segment have a cord cross-sectional area, a sum of the cord cross-sectional areas of the left cord first segment, the left cord second segment, the right cord first segment and the right cord second segment being about 2 to 2.5 times greater than a cross-sectional area of the cord constraining passage.

Item 26: The non-medical face mask of any preceding item, wherein:

each of the left cord first segment, the left cord second segment, the right cord first segment and the right cord second segment have a cord cross-sectional area, and the unitary retaining bead reduces a sum of the cord cross-sectional areas of the left cord first segment, the left cord second segment, the right cord first segment and the right cord second segment within the cord constraining passage by at least 25%.

Item 27: The non-medical face mask of any preceding item, wherein:

each of the left and right cords have an elasticity of less than 10%.

Item 28: The non-medical face mask of any preceding item, wherein:

each of the left and right cords comprise one of braided polyester, braided nylon, braided polypropylene, and braided aramid.

Item 29: The non-medical face mask of any preceding item, wherein:

each of the left and right cords comprise one of polyester, nylon, polypropylene, and aramid.

Item 30: The non-medical face mask of any preceding item, wherein:

the left cord channel extends from a left channel upper exit to a left channel lower exit, the right cord channel extends from a right channel upper exit to a right channel lower exit, and advancing the unitary retaining bead toward the mask body reduces
i) a portion of the left cord that extends from the unitary retaining bead to each of the left channel upper and lower exits, and
ii) a portion of the right cord that extends from the unitary retaining bead to each of the right channel upper and lower exits.
   Item 31: The non-medical face mask of any preceding item, wherein:

the left cord has a left cord length, the right cord has a right cord length, the left cord channel has a left cord channel length, the right cord channel has a right cord channel length, a ratio of the left cord length to the left cord channel length is between 15 to 1 and 10 to 1, and a ratio of the right cord length to the right cord channel length is between 15 to 1 and 10 to 1.

Item 32: The non-medical face mask of any preceding item, wherein:

the mask body comprises at least one layer of pliant fabric having laterally opposed left and right fabric ends, and lengths of the left and right cord channels are bounded at least in part by respective hems of the left and right fabric ends.

Item 33: The non-medical face mask of any preceding item, wherein the mask body comprises a laterally extending nose bar channel centrally located along the upper mask body edge, the nose bar channel having a bendable nose bar insertion opening.
Item 34: A kit comprising:

the non-medical face mask of any preceding item; and

at least two bendable nose bars.

Item 35: A non-medical face mask comprising:

a mask body having upper and lower body edges spaced apart from one another by laterally opposed left and right body edges;

a left cord extending from a left cord first end to a left cord second end, the left cord having a connection to the left body edge between the left cord first and second ends, the left cord having a left cord first segment proximate the left cord first end and a left cord second segment proximate the left cord second end;

a right cord extending from a right cord first end to a right cord second end, the right cord having a connection to the right body edge between the right cord first and second ends, the right cord having a right cord first segment proximate the right cord first end and a right cord second segment proximate the right cord second end; and

a unitary retaining bead having a cord constraining passage, each of the left cord first segment, the left cord second segment, the right cord first segment and the right cord second segment passing through the cord constraining passage, the cord constraining passage being sized to frictionally engage the left cord first segment, the left cord second segment, the right cord first segment and the right cord second segment such that the unitary retaining bead is held in place along each of the left cord first segment, the left cord second segment, the right cord first segment and the right cord second segment, the unitary retaining bead being slidable along each of the left cord first segment, the left cord second segment, the right cord first segment and the right cord second segment to advance the unitary retaining bead toward the mask body,

wherein the left cord first and second ends are tied through a left cord knot, and the right cord first and second ends are tied through a right cord knot, the left cord knot obstructing removal of the unitary retaining bead from the left cord first and second ends, and the right cord knot obstructing removal of the unitary retaining bead from the right cord first and second ends.

Item 36: The non-medical face mask of any preceding item, wherein:

wherein the mask body has a left cord channel and a right cord channel, the connection of the left cord comprises the left cord extending through the left cord channel, and the connection of the right cord comprises the right cord extending through the right cord channel.

1. A non-medical face mask comprising:
a mask body having upper and lower body edges spaced apart from one another by laterally opposed left and right body edges, the mask body having a left cord channel along the left body edge and a right cord channel along the right body edge;
a left cord extending from a left cord first end through the left cord channel to a left cord second end, the left cord being slidable within the left cord channel, the left cord having a left cord first segment proximate the left cord first end and a left cord second segment proximate the left cord second end;
a right cord extending from a right cord first end through the right cord channel to a right cord second end, the right cord being slidable within the right cord channel, the right cord having a right cord first segment proximate the right cord first end and a right cord second segment proximate the right cord second end; and
a unitary retaining bead having a cord constraining passage, each of the left cord first segment, the left cord second segment, the right cord first segment and the right cord second segment passing through the cord constraining passage, the cord constraining passage being sized to frictionally engage the left cord first segment, the left cord second segment, the right cord first segment and the right cord second segment such that the unitary retaining bead is held in place along each of the left cord first segment, the left cord second segment, the right cord first segment and the right cord second segment, the unitary retaining bead being slidable along each of the left cord first segment, the left cord second segment, the right cord first segment and the right cord second segment to advance the unitary retaining bead toward the mask body.

2. The non-medical face mask of claim 1, wherein a portion of each of the left cord first segment, the left cord second segment, the right cord first segment and the right cord second segment that is within the cord constraining passage is compressed by the unitary retaining bead.

3. The non-medical face mask of claim 2, wherein each of the left cord first segment, the left cord second segment, the right cord first segment and the right cord second segment have a cord cross-sectional area, a sum of the cord cross-sectional areas of the left cord first segment, the left cord second segment, the right cord first segment and the right cord second segment being about 2 to 2.5 times greater than a cross-sectional area of the cord constraining passage.

4. The non-medical face mask of claim 2, wherein each of the left cord first segment, the left cord second segment, the right cord first segment and the right cord second segment have a cord cross-sectional area, and the unitary retaining bead reduces a sum of the cross-sectional areas of the left cord first segment, the left cord second segment, the right cord first segment and the right cord second segment within the cord constraining passage by at least 25%.

5. The non-medical face mask of claim 1, wherein the unitary retaining bead is trapped on each of the left cord first segment, the left cord second segment, the right cord first segment and the right cord second segment.

6. The non-medical face mask of claim 1, wherein the left cord first and second ends are tied, and the right cord first and second ends are tied.

7. The non-medical face mask of claim 6, wherein the left cord first and second segments are together slidable through the cord constraining passage independently of the right cord first and second segments.

8. The non-medical face mask of claim 6, wherein the left cord first and second ends are tied through a left cord knot, and the right cord first and second ends are tied through a right cord knot, the left cord knot obstructing removal of the unitary retaining bead from the left cord first and second ends, and the right cord knot obstructing removal of the unitary retaining bead from the right cord first and second ends.

9. The non-medical face mask of claim 8, wherein each of the left and right cord knots are fused to impede unknotting.

10. The non-medical face mask of claim 1, wherein each of the left and right cords have an elasticity of less than 10%.

11. The non-medical face mask of claim 10, wherein each of the left and right cords comprise one of braided polyester, braided nylon, braided polypropylene, and braided aramid.

12. The non-medical face mask of claim 1, wherein the left cord channel extends from a left channel upper exit to a left channel lower exit, the right cord channel extends from a right channel upper exit to a right channel lower exit, and advancing the unitary retaining bead toward the mask body reduces
i) a portion of the left cord that extends from the unitary retaining bead to each of the left channel upper and lower exits, and
ii) a portion of the right cord that extends from the unitary retaining bead to each of the right channel upper and lower exits.

13. The non-medical face mask of claim 1, wherein the left cord has a left cord length, the right cord has a right cord length, the left cord channel has a left cord channel length, the right cord channel has a right cord channel length, a ratio of the left cord length to the left cord channel length is between 15 to 1 and 10 to 1, and a ratio of the right cord length to the right cord channel length is between 15 to 1 and 10 to 1.

14. The non-medical face mask of claim 1, wherein the mask body comprises at least one layer of pliant fabric having laterally opposed left and right fabric ends, and lengths of the left and right cord channels are bounded at least in part by respective hems of the left and right fabric ends.

15. The non-medical face mask of claim 1, wherein the mask body comprises a laterally extending nose bar channel located along the upper mask body edge, the nose bar channel having a bendable nose bar insertion opening.

16. A kit comprising:
the non-medical face mask of claim 15; and
at least two bendable nose bars.

17. A non-medical face mask comprising:
a mask body having upper and lower body edges spaced apart from one another by laterally opposed left and right body edges, the mask body having a left cord channel along the left body edge and a right cord channel along the right body edge;
a left cord extending from a left cord first end through the left cord channel to a left cord second end, the left cord having a left cord first segment proximate the left cord first end and a left cord second segment proximate the left cord second end;
a right cord extending from a right cord first end through the right cord channel to a right cord second end, the right cord having a right cord first segment proximate the right cord first end and a right cord second segment proximate the right cord second end; and
a unitary retaining bead having a cord constraining passage, each of the left cord first segment, the left cord second segment, the right cord first segment and the right cord second segment passing through the cord constraining passage, the cord constraining passage being sized to frictionally engage the left cord first segment, the left cord second segment, the right cord first segment and the right cord second segment such that the unitary retaining bead is held in place along each of the left cord first segment, the left cord second segment, the right cord first segment and the right cord second segment, the unitary retaining bead being slidable along each of the left cord first segment, the left cord second segment, the right cord first segment and the right cord second segment to advance the unitary retaining bead toward the mask body,
wherein the left cord first and second ends are tied through a left cord knot, and the right cord first and second ends are tied through a right cord knot, the left cord knot obstructing removal of the unitary retaining bead from the left cord first and second ends, and the right cord knot obstructing removal of the unitary retaining bead from the right cord first and second ends.

18. The non-medical face mask of claim 17, wherein the left cord is slidable within the left cord channel and the right cord is slidable within the right cord channel.

19. A non-medical face mask comprising:
a mask body having upper and lower body edges spaced apart from one another by laterally opposed left and right body edges;
a left cord extending from a left cord first end to a left cord second end, the left cord having a connection to the left body edge between the left cord first and second ends, the left cord having a left cord first segment proximate the left cord first end and a left cord second segment proximate the left cord second end;
a right cord extending from a right cord first end to a right cord second end, the right cord having a connection to the right body edge between the right cord first and second ends, the right cord having a right cord first segment proximate the right cord first end and a right cord second segment proximate the right cord second end; and
a unitary retaining bead having a cord constraining passage, each of the left cord first segment, the left cord second segment, the right cord first segment and the right cord second segment passing through the cord constraining passage, the cord constraining passage being sized to frictionally engage the left cord first segment, the left cord second segment, the right cord first segment and the right cord second segment such that the unitary retaining bead is held in place along each of the left cord first segment, the left cord second segment, the right cord first segment and the right cord second segment, the unitary retaining bead being slidable along each of the left cord first segment, the left cord second segment, the right cord first segment and the right cord second segment to advance the unitary retaining bead toward the mask body,
wherein the left cord first and second ends are tied through a left cord knot, and the right cord first and second ends are tied through a right cord knot, the left cord knot obstructing removal of the unitary retaining bead from the left cord first and second ends, and the right cord knot obstructing removal of the unitary retaining bead from the right cord first and second ends.

20. The non-medical face mask of claim 19, wherein the mask body has a left cord channel and a right cord channel, the connection of the left cord comprises the left cord extending through the left cord channel, and the connection of the right cord comprises the right cord extending through the right cord channel.
